(19) United States
(12) Patent Application Publication
(10) Pub. No.: US 2014/0287604 A1
(43) Pub. Date: Sep. 25, 2014

(54) TERMINAL, TERMINAL MODULE AND METHOD OF MANUFACURING THE TERMINAL MODULE

(71) Applicant: HON HAI PRECISION INDUSTRY CO., LTD., New Taipei (TW)

(72) Inventors: PO-YUAN LIN, New Taipei (TW); LI-DONG TANG, Kunshan (CN); CHIH-HAO LEE, New Taipei (TW)

(73) Assignee: HON HAI PRECISION INDUSTRY CO., LTD., New Taipei (TW)

(21) Appl. No.: 14/222,691

(22) Filed: Mar. 24, 2014

(30) Foreign Application Priority Data
Mar. 22, 2013 (CN) 2013100939405

(51) Int. Cl. H01R 12/55; H01R 43/20; H01R 13/02

(52) U.S. Cl. CPC H01R 12/55; H01R 13/02; H01R 43/205
USPC 439/83; 439/891; 29/843

(57) ABSTRACT

A terminal comprises an upper arm having a top surface for a mating area; a lower arm paralleled with the upper arm and having a bottom surface soldering area; and a connecting arm connected with the upper arm and the lower arm.

### FIELD OF THE INVENTION

The present invention generally relates to a terminal module and method of manufacturing the same, more specifically to a terminal module and method of manufacturing the same which is applied in an terminal for signal transmission.

### DESCRIPTION OF PRIOR ART

In existing technology, terminals accommodated in terminal are required to meet a certain height due to a design of whole structure of the terminal To meet aforementioned requirement, the terminal can be formed by one unitary piece to achieve a height or thickness requirement through a stamping or similar process from a metal sheet or can be formed by two relatively thin pieces of terminals which are stacked with each other. Whereas, two aforementioned manufacturing processes of terminal both need a large amount of copper, and not cost-effective. In addition, the terminal formed by two pieces of sub-terminals has difficult and complicated manufacturing process. Meanwhile, the terminal itself has great impedance values due to a certain thickness result in weak signal transmission through the terminal. Thus, the terminal cannot satisfy the requirement of signal transmission.

On the other hand, some problems have been existed during a soldering process between the terminals and the printed circuit board. For example, when conductive pads of the printed circuit board are soldered to the corresponding terminals through hot-bar or surface mount technology(SMT) process, however soldering pastes located on two adjacent conductive pads will not be well controlled. Thus, two adjacent soldering plates will be connected with each other well during a hot-bar or SMT process between the terminals and the printed circuit board. Thus, a short circuit between two adjacent conductive pads of the printed circuit board will be happened. As a result, defective rate of product manufacturing will be high.

A terminal module with an improved terminal overcoming shortages of existing technology is needed.

### SUMMARY OF THE INVENTION

Accordingly, an object of the present invention is to provide a terminal with a certain thickness to meet a profile of an electrical connector and lower cost .

In order to achieve the above-mentioned object, A terminal comprises an upper arm having a top surface for a mating area; a lower arm paralleled with the upper arm and having a bottom surface soldering area; and a connecting arm connected with the upper arm and the lower arm.

Accordingly, another object of the present invention is to provide a terminal module with improved terminal and easily manufactured.

In order to achieve the above-mentioned object, a terminal module comprises: a printed circuit board having a plurality of front and rear conductive pads; and a plurality of terminals soldered to the printed circuit board. Each of terminal comprises paralleled upper and lower arms and a connecting arm connected with the upper arm and the lower arm, the upper arm defines a contacting area on a top surface thereof, the lower arm defines a soldering area on a bottom surface thereof, the plurality of terminals are located on the plurality of corresponding front conductive pads, and the lower arms of the plurality of terminals are soldered to the plurality of corresponding front conductive pads.

Other objects, features and advantages of the invention will be apparent from the following detailed description taken in connection with the accompanying drawings.

### BRIEF DESCRIPTION OF THE DRAWINGS

FIG. 1 is a perspective view of a terminal in accordance with the first embodiment of present invention;

FIG. 2 is another perspective view of FIG. 1;

FIG. 3 is a perspective view of a terminal strip with a plurality of terminals of first embodiment of present invention;

FIG. 4 is a perspective view of a terminal strip with a plurality of unbent terminals of first embodiment of present invention;

FIG. 5 is a perspective view of a terminal in accordance with the second embodiment of present invention;

FIG. 6 is another perspective view of FIG. 5;

FIG. 7 is a perspective view of a terminal in accordance with the third embodiment of present invention;

FIG. 8 is another perspective view of FIG. 7;

FIG. 9 is a perspective view of a terminal in accordance with the fourth embodiment of present invention;

FIG. 10 is another perspective view of FIG. 9;

FIG. 11 is a cross-section view take along line 11-11 of FIG. 9;

FIG. 12 is a perspective view of a terminal in accordance with the fifth embodiment of present invention;

FIG. 13 is another view of FIG. 12;

FIG. 14 is a cross-section view take along line 14-14 of FIG. 12;

FIG. 15 is a perspective view of a terminal in accordance with the sixth embodiment of present invention;

FIG. 16 is another view of FIG. 15;

FIG. 17 is a cross-section view take along line 17-17 of FIG. 15;

FIG. 18 is a perspective view of a terminal in accordance with the seventh embodiment of present invention;

FIG. 19 is another view of FIG. 18;

FIG. 20 is a cross-section view take along line 20-20 of FIG. 18;

FIG. 21 is a perspective view of a terminal in accordance with the eighth embodiment of present invention;

FIG. 22 is another view of FIG. 21;

FIG. 23 is a cross-section view take along line 23-23 of FIG. 21;

FIG. 24 is a perspective view of a terminal module in accordance with the first embodiment of present invention;

FIG. 25 is an exploded, perspective view of FIG. 24;

FIG. 26 is a cross-section view take along line 26-26 of FIG. 24;

FIG. 27 is a perspective view of a terminal module in accordance with the second embodiment of present invention;

FIG. 28 is an exploded, perspective view of FIG. 27;

FIG. 29 is a cross-section view take along line 29-29 of FIG. 27;

FIG. 30 is a perspective view of a terminal module in accordance with the second embodiment of present invention;

FIG. 31 is an exploded, perspective view of FIG. 30; and

FIG. 32 is a cross-section view take along line 32-32 of FIG. 30.

### DETAILED DESCRIPTION OF PREFERRED EMBODIMENTS

Reference will now be made to the drawing figures to describe the present invention in detail.

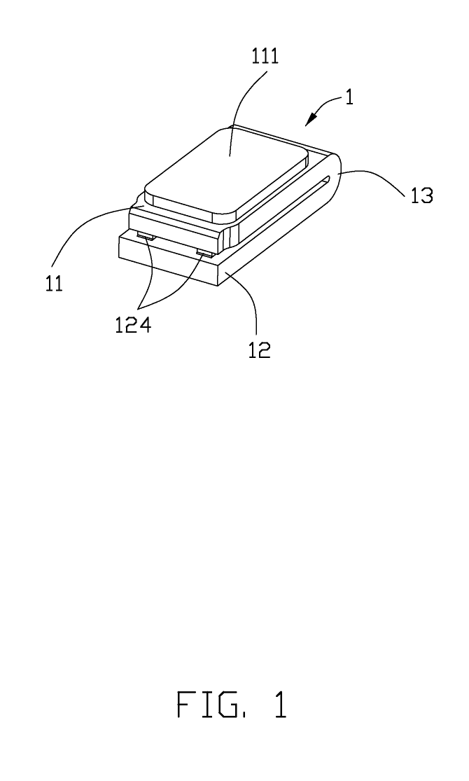

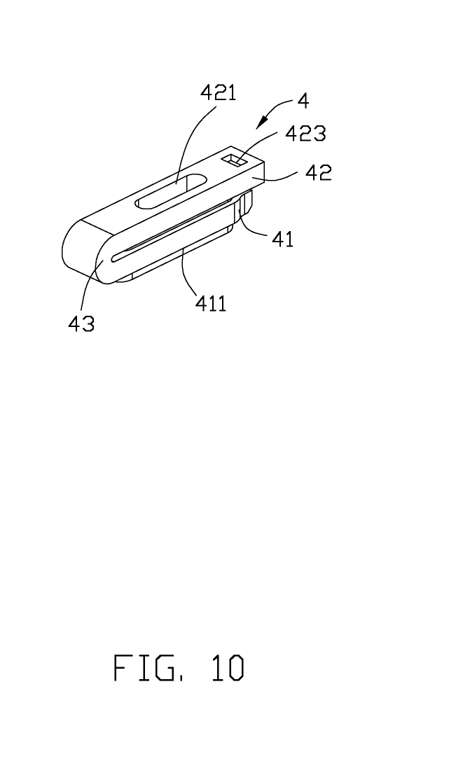

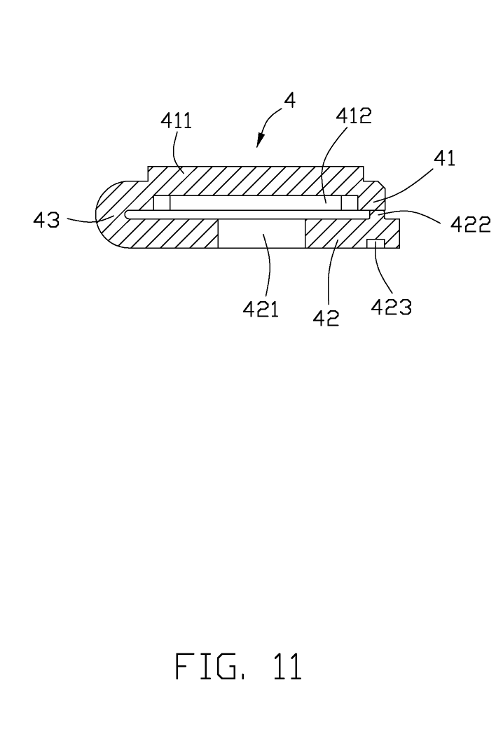

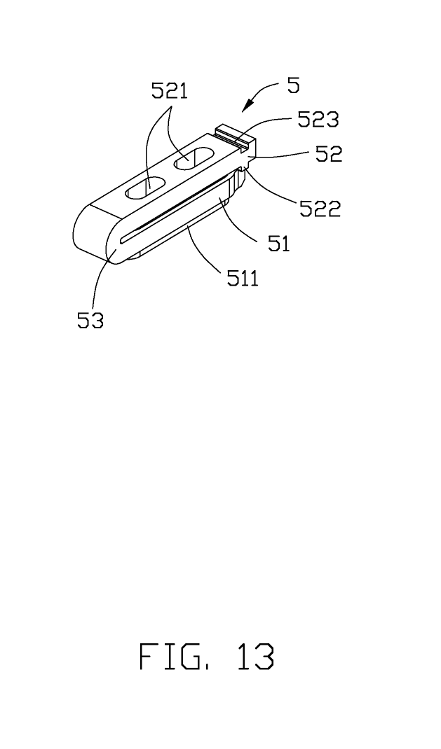

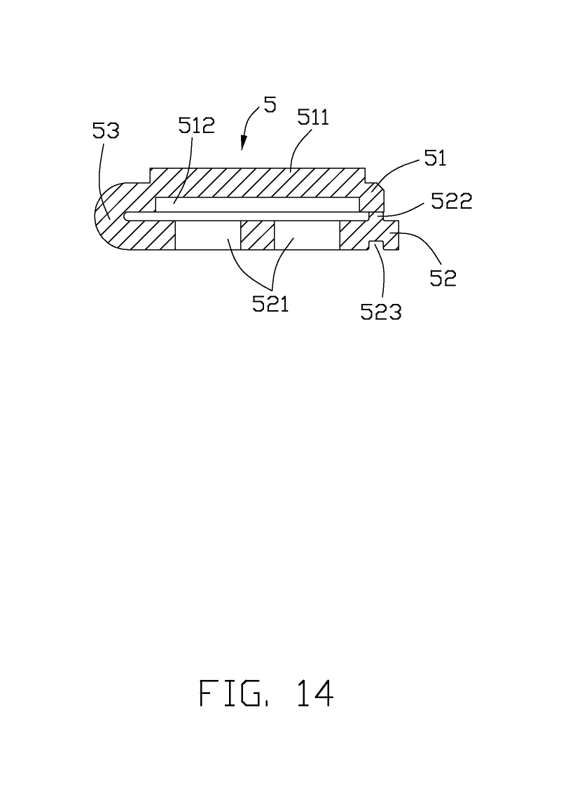

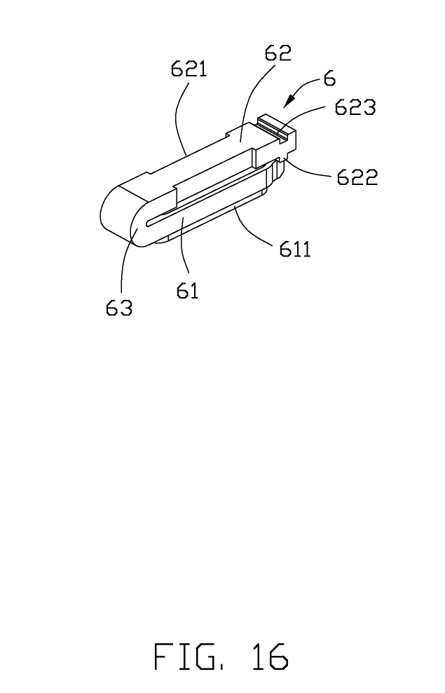

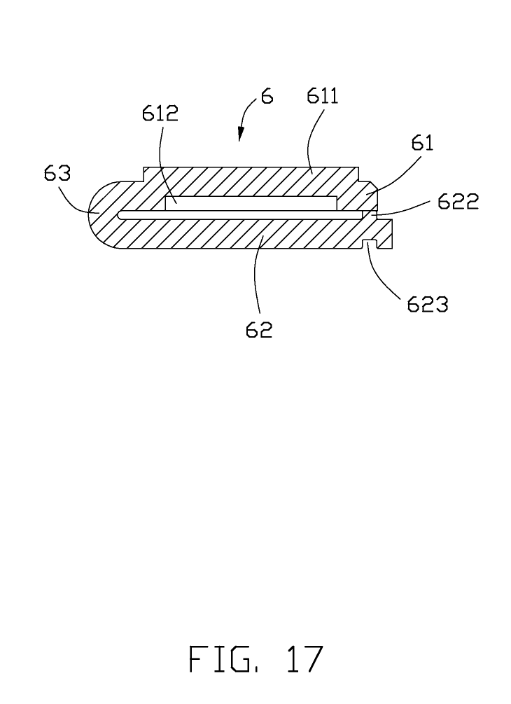

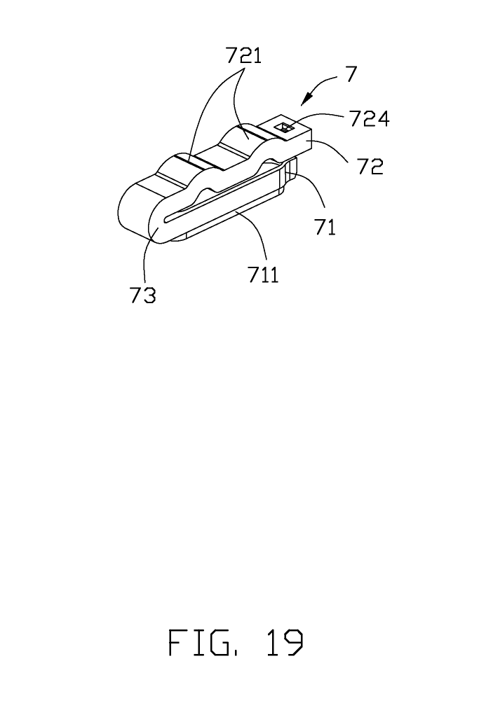

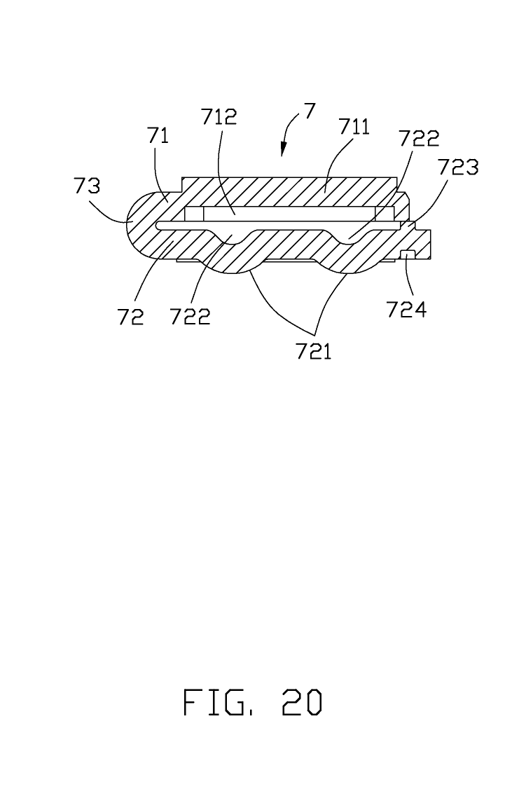

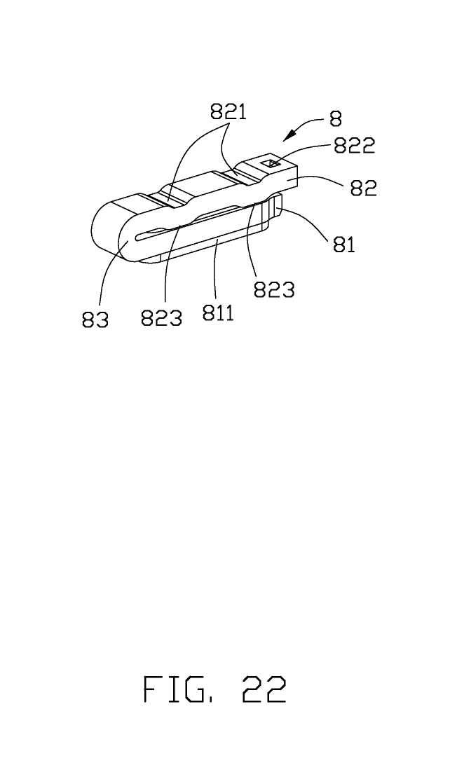

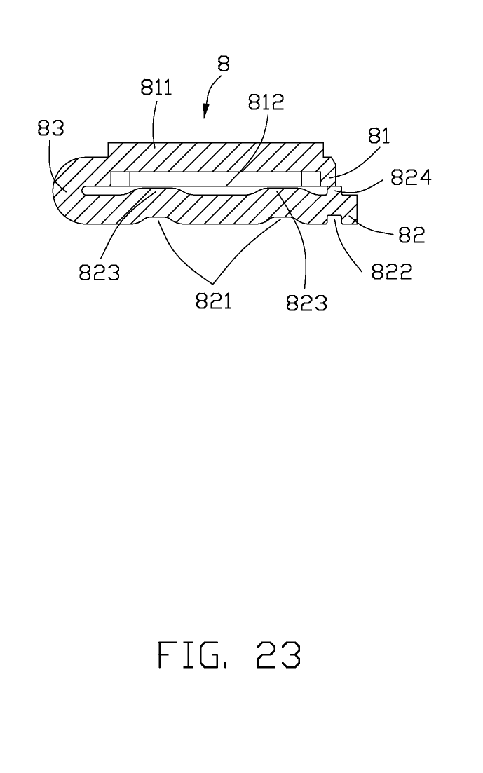

Referring to FIGS. 1 to 23, a terminal in accordance with present invention relates to a type of folding terminal. Through bending process, a thickness of the whole terminal can meet a profile of an electrical connector especially in a thickness aspect. The terminal in accordance with present invention is used to solder to a printed circuit board.

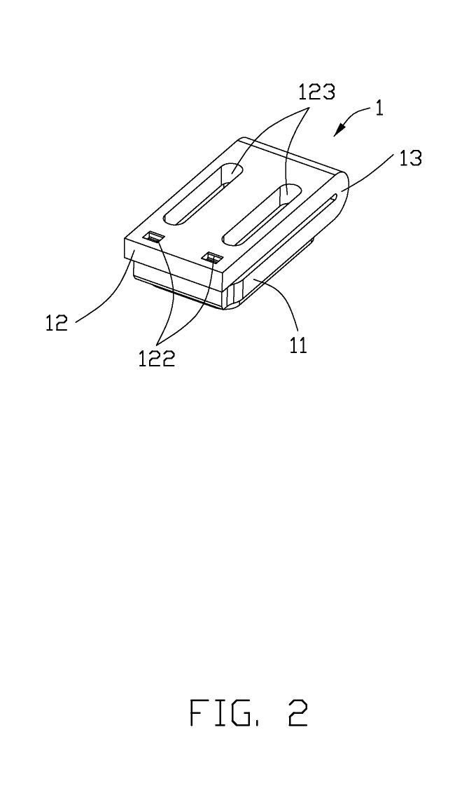

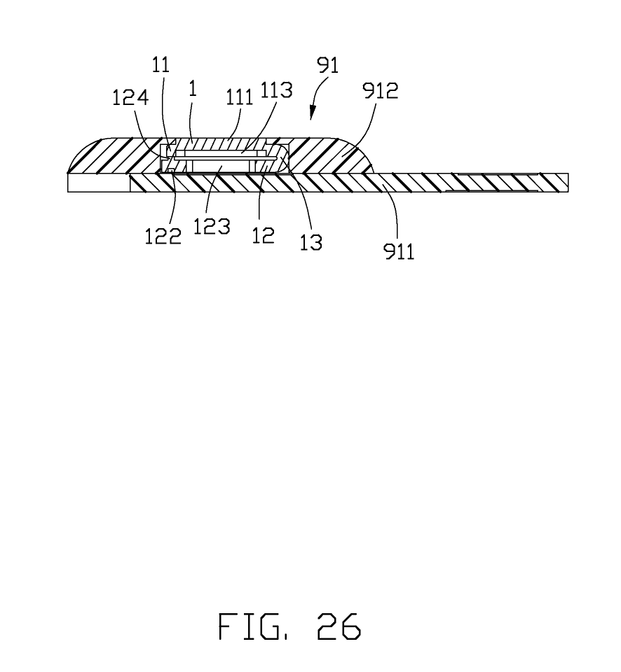

Referring to FIGS. 1 to 2 and in conjunction with FIG. 26, a terminal 1 in accordance with the first embodiment of present invention is detailed described as below. The terminal 1 is generally structured in a U-shape, and comprises an upper arm 11, a lower arm 12 paralleled with the upper arm 11 and a curved connecting arm 13 connected with the upper and lower arms 11, 12. The upper arm 11 defines a rectangular convex/raised plate 111 formed on a top surface thereof And, a periphery of top surface of the upper arm 11 is not cover by the convex plate 111. A top surface of the convex plate 111 is a mating area of the terminal 1 for signal transmission. A bottom surface of the lower arm 12 is a soldering area of the terminal 1 for soldering to a printed circuit board 911. The terminal 1 is formed by stamping process. The upper arm 11 defines a depression 113 formed on a bottom surface thereof and in alignment with the convex plate 111 along a vertical direction. The lower arm 12 defines two through slots 123 spaced apart each other along a transversal direction and respectively extending along a longitudinal direction. The lower arm 12 further defines two recesses 122 respectively formed on a bottom surface thereof and located in front of the two through slots 123. The lower arm 12 further defines two projections 124 formed on a top surface thereof and in alignment with two recesses 122 along a vertical direction. Two projections 124 are attached to the bottom surface of the upper arm 11. It should be noted that the through slots 123 are used to achieve a fully integration between soldering paste (not labeled) located on the conductive pads 9111 and the corresponding terminals 1. Thus, a good mechanical and electrical connection between the printed circuit board 911 and the terminals 1 is achieved.

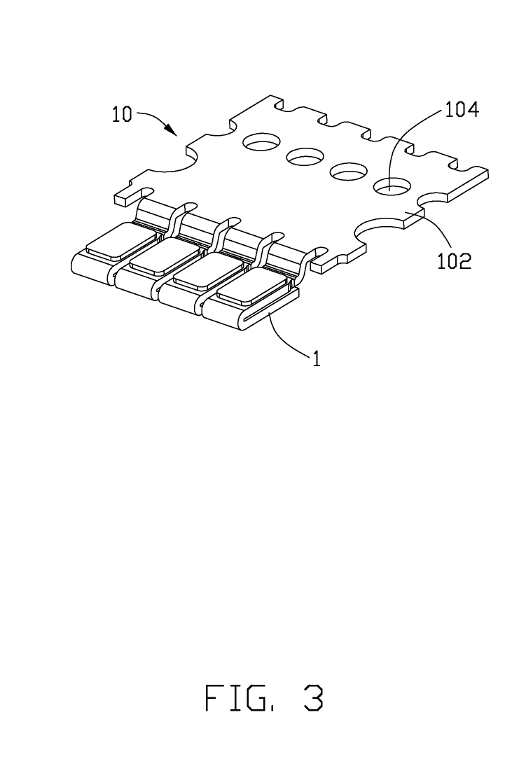

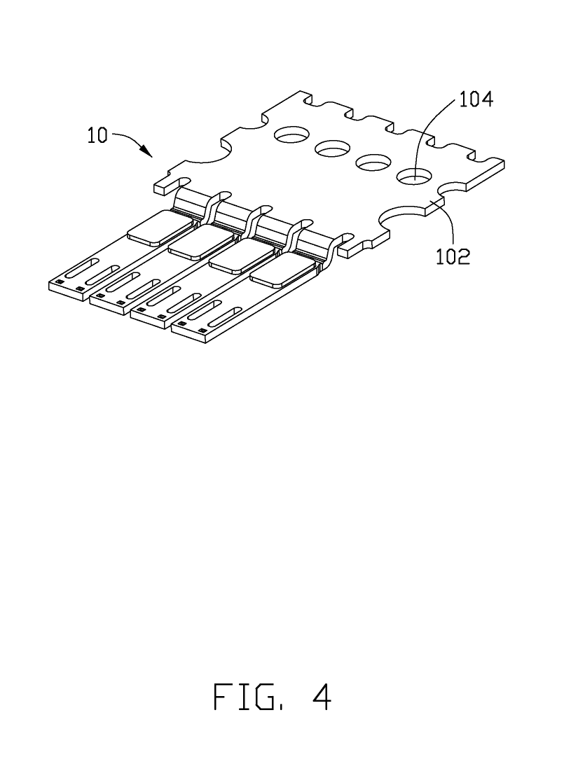

Referring to FIGS. 3 to 4, two structures of a terminal strip 10 are clearly shown in FIGS. 3 and FIGS. 4. Please refer to FIG. 3, it shows a terminal strip 10 comprising a plurality of terminals 1 and a material strap 10 connected with the material strap 10. Please refer to FIG. 4, it shows a terminal strip 10 comprising a plurality of unbent terminals 1 and a material strap 10 connected with the plurality of unbent terminals 1. The material strap 10 defines a plurality of positioning holes 104 formed thereon. The terminal strip 10 is formed by stamping process.

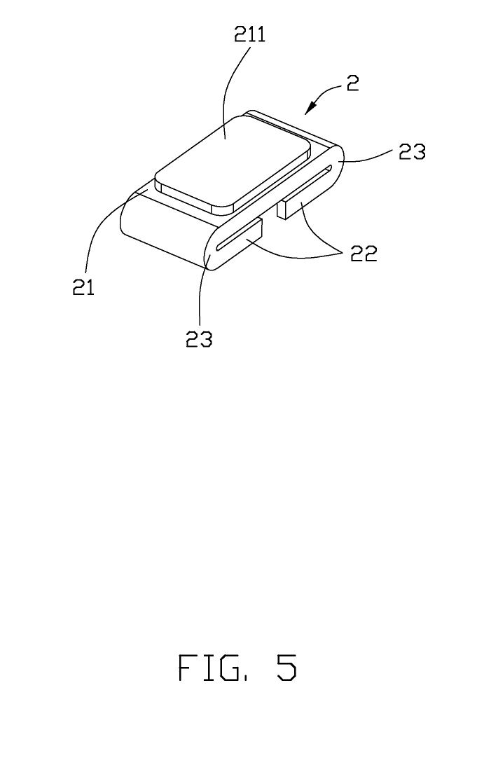

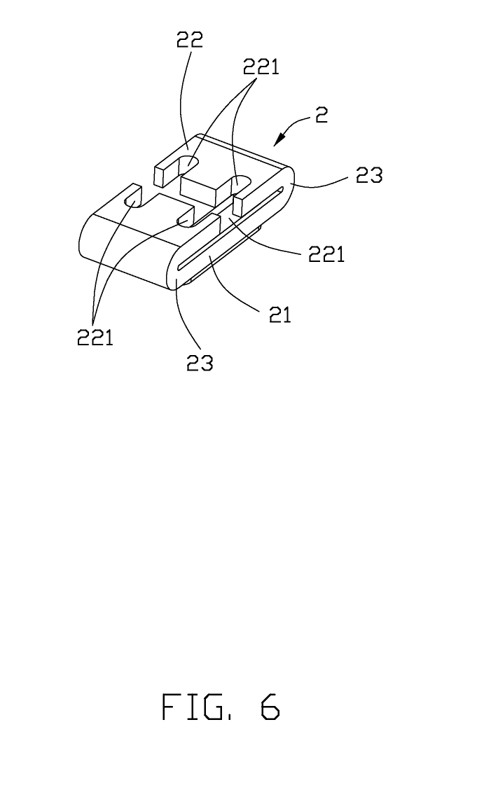

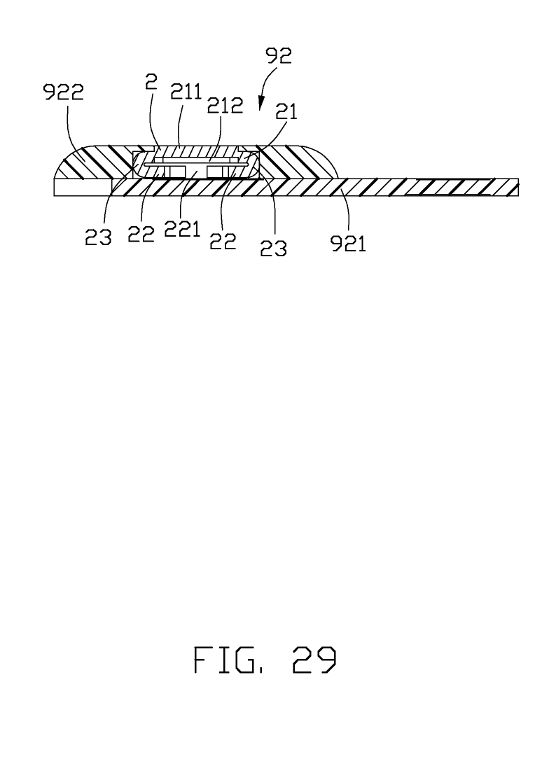

Referring to FIGS. 5 to 6 and in conjunction with FIG. 29, a terminal 2 in accordance with the second embodiment of present invention is detailed described as below. The terminal 2 comprises an upper arm 21, a lower arm 22 paralleled with the upper arm 21 and two curved connecting arms 23 respectively connected with the upper and lower arms 21, 22. The lower arm 22 defines a plurality of through slots 221 throughout top and bottom surfaces thereof One of the through slots 221 extends throughout two lateral sides of the lower arm 22. The upper arm 21 defines a rectangular convex plate 211 formed on a top surface thereof And, a periphery of top surface of the upper arm 21 is not cover by the convex plate 211. A top surface of the convex plate 211 is a mating area of the terminal 1 for signal transmission. A bottom surface of the lower arm 22 is a soldering area of the terminal 2 for soldering to a printed circuit board 921. The terminal 2 is formed by stamping process. It should be noted that the through slots 221 are used to achieve a fully integration between soldering paste (not labeled) located on the conductive pads 9111 and the corresponding terminals 2. Thus, a good mechanical and electrical connection between the printed circuit board 921 and the terminals 2 is achieved.

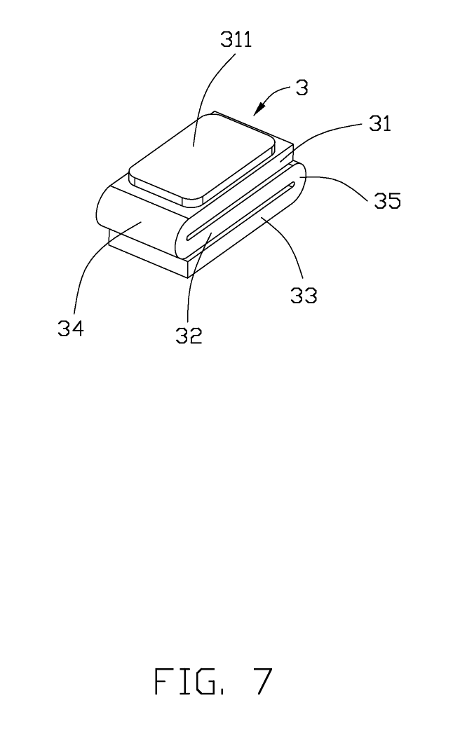

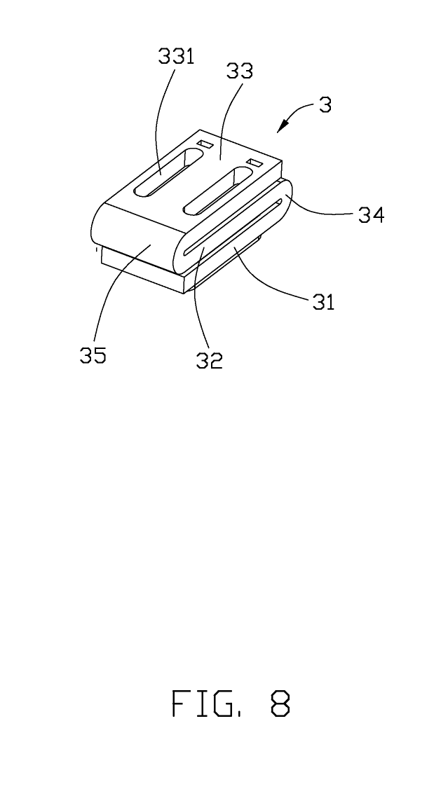

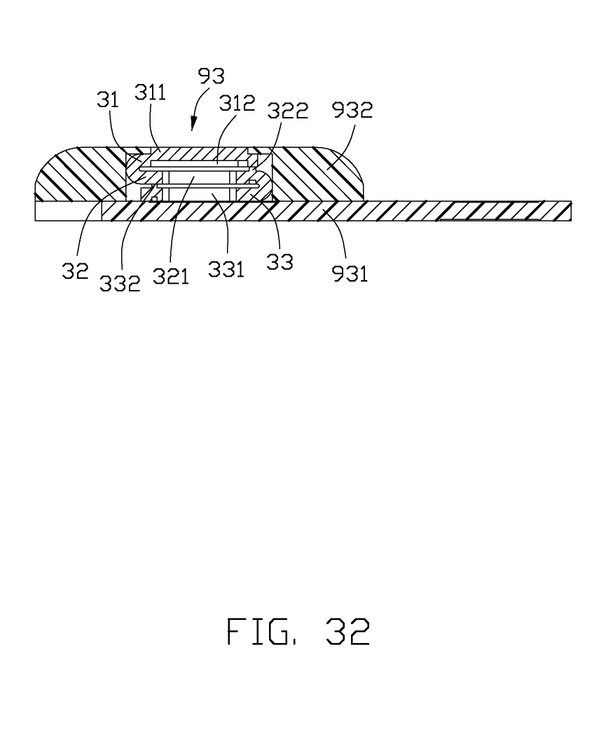

Referring to FIGS. 7 to 8 and in conjunction with FIG. 32, a terminal 3 in accordance with the third embodiment of present invention is detailed described as below. The terminal 3 is generally structured in a S-shape, and comprises an upper arm 31, an intermediate arm 32 and a lower arm 33 paralleled with each other. The terminal 3 further comprises a curved connecting arm 34 connected with the upper arm 31 and the intermediate arm 32, and another curved connecting arm 35 connected with the intermediate arm 32 and the lower arm 33. The intermediate arm 32 and the lower arm 33 respectively defines two through slots 321, 331 spaced apart with each other along a transversal direction. And the two through slots 321 are respectively in alignment with two through slots 331 along a vertical direction. The upper arm 31 defines a rectangular convex plate 311 formed on a top surface thereof and a depression 312 formed on bottom surface thereof and in alignment with the convex plate 311 along a vertical direction. And, a periphery of top surface of the upper arm 31 is not covered by the convex plate 311. The intermediate arm 32 defines a projection 322 attached to the bottom surface of the upper arm 31. The projection 322 is formed on a top surface and rear side of the intermediate arm 32. The lower arm 33 also defines a projection 332 attached to a bottom surface of the intermediate arm 32. The projection 332 is formed on a top surface and front side of the lower arm 33. A top surface of the convex plate 311 is a mating area of the terminal 3 for signal transmission. A bottom surface of the lower arm 33 is a soldering area of the terminal 3 for soldering to a printed circuit board 931. The terminal 3 is formed by stamping process. It should be noted that the through slots 331 of the lower arm 33 are used to achieve a fully integration between soldering paste (not labeled) located on the conductive pads 9111 and the corresponding terminals 3. Thus, a good mechanical and electrical connection between the printed circuit board 921 and the terminals 2 is achieved due to the through slots 331.

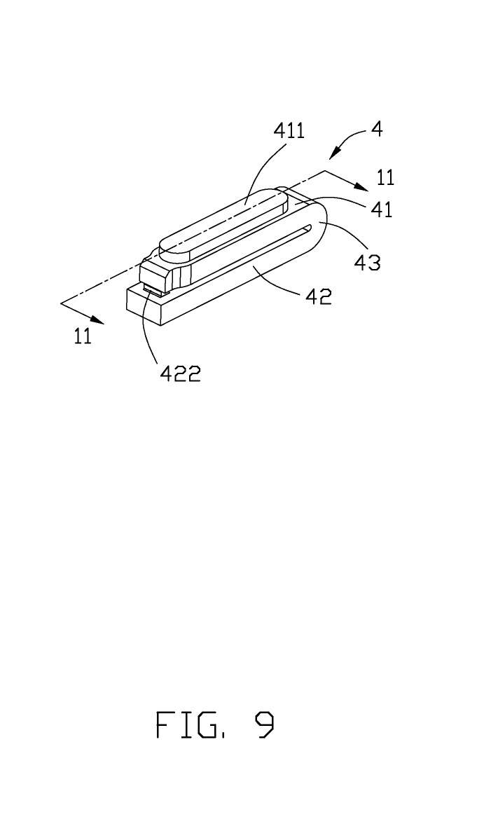

Referring to FIGS. 9 to 11, a terminal 4 in accordance with the fourth embodiment of present invention is detailed described as below. The terminal 4 is formed by once folding process and generally structured in a U-shape. The terminal 4 comprises an upper arm 41, a lower arm 42 paralleled with the upper arm 41 and a curved connecting arm 43 connected with the upper arm 41 and the lower arm 42. The lower arm 42 defines a through slot 421 extending throughout top and bottom surfaces thereof The lower arm 42 defines a projection 422 attached to a bottom surface of the upper arm 41. The projection 422 is formed on a top surface and a front side of the lower arm 42. The lower arm 42 also defines a recess 423 in alignment with the projection 422 along a vertical direction. The upper arm 41 defines a rectangular convex plate 411 formed on a top surface thereof and a depression 412 formed on a bottom surface thereof And, a periphery of top surface of the upper arm 41 is not covered by the convex plate 411. A top surface of the convex plate 411 is a mating area of the terminal 4 for signal transmission. A bottom surface of the lower arm 42 is a soldering area of the terminal 4 for soldering to a printed circuit board. The terminal 4 is formed by stamping process. The depression 412 is in alignment with the convex plate 411 along a vertical direction. It should be noted that the through slot 421 is used to achieve a fully integration between soldering paste (not labeled) located on the conductive pad and the corresponding terminal 4. Thus, a good mechanical and electrical connection between the printed circuit board and the terminal 4 is achieved due to the through slot 421.

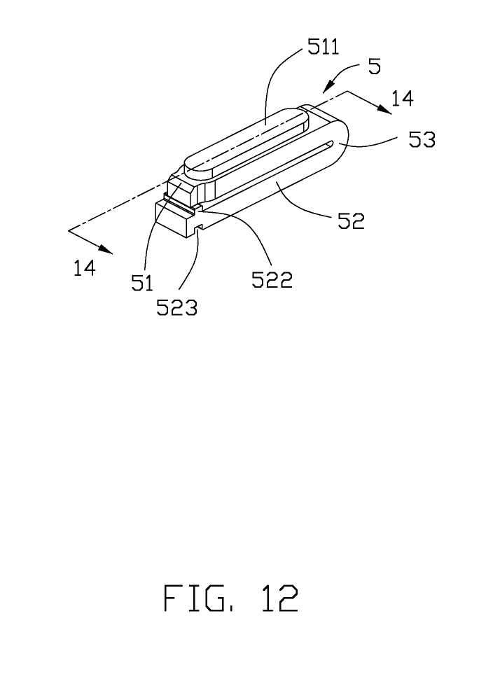

Referring to FIGS. 12 to 14, a terminal 5 in accordance with the fifth embodiment of present invention is detailed described as below. The terminal 5 is formed by once folding process and generally structured in a U-shape. The terminal 5 comprises an upper arm 51, a lower arm 52 paralleled with the upper arm 51 and a curved connecting arm 53 connected with the upper arm 51 and the lower arm 52. The lower arm 52 defines two through slots 521 extending throughout top and bottom surfaces thereof The two through slots 521 are arranged in a line and spaced apart with each other along a front-to-rear direction. The lower arm 52 defines a projection 522 attached to a bottom surface of the upper arm 51. The projection 522 is formed on a top surface and a front side of the lower arm 52. The lower arm 52 also defines a recess 523 in alignment with the projection 522 along a vertical direction. The recess 523 extends throughout two sides of the lower arm 52. The upper arm 51 defines a rectangular convex plate 511 formed on a top surface thereof and a depression 512 formed on a bottom surface thereof And, a periphery of top surface of the upper arm 51 is not covered by the convex plate 511. A top surface of the convex plate 511 is a mating area of the terminal 5 for signal transmission. A bottom surface of the lower arm 52 is a soldering area of the terminal 5 for soldering to a printed circuit board. The terminal 5 is formed by stamping process. The depression 512 is in alignment with the convex plate 511 along a vertical direction. It should be noted that the two through slots 521 are used to achieve a fully integration between soldering paste (not labeled) located on the conductive pad of the printed circuit board and the corresponding terminal 5. Thus, a good mechanical and electrical connection between the printed circuit board and the terminal 5 is achieved due to the through slots 521.

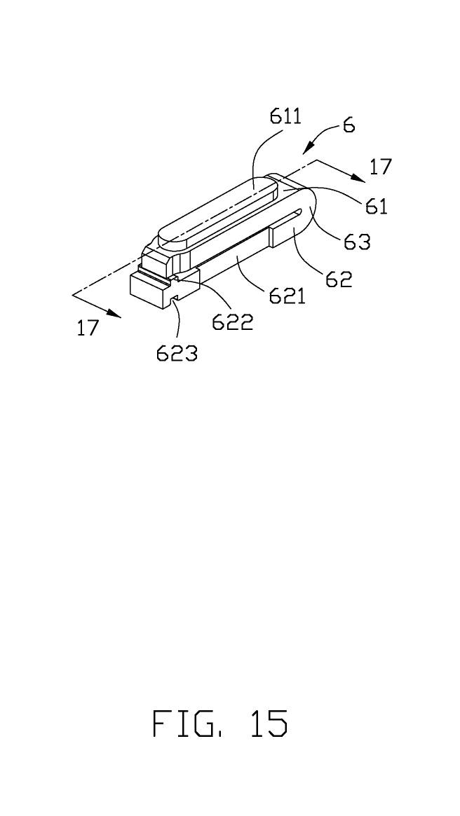

Referring to FIGS. 15 to 17, a terminal 6 in accordance with the sixth embodiment of present invention is detailed described as below. The terminal 6 is formed by once folding process and generally structured in a U-shape. The terminal 6 comprises an upper arm 61, a lower arm 62 paralleled with the upper arm 61 and a curved connecting arm 63 connected with the upper arm 61 and the lower arm 62. The lower arm 62 defines two through slots 621 formed at two sides thereof and extending throughout top and bottom surfaces thereof The lower arm 62 defines a projection 622 attached to a bottom surface of the upper arm 61. The projection 622 is formed on a top surface and a front side of the lower arm 62. The lower arm 62 also defines a recess 623 in alignment with the projection 622 along a vertical direction. The recess 623 extends throughout two sides of the lower arm 62. The upper arm 61 defines a rectangular convex plate 611 formed on a top surface thereof and a depression 612 formed on a bottom surface thereof And, a periphery of top surface of the upper arm 61 is not covered by the convex plate 611. A top surface of the convex plate 611 is a mating area of the terminal 6 for signal transmission. A bottom surface of the lower arm 62 is a soldering area of the terminal 6 for soldering to a printed circuit board. The terminal 6 is formed by stamping process. The depression 612 is in alignment with the convex plate 611 along a vertical direction. It should be noted that the two through slots 621 are used to achieve a fully integration between soldering paste (not labeled) located on the conductive pad of the printed circuit board and the corresponding terminal 5. Thus, a good mechanical and electrical connection between the printed circuit board and the terminal 5 is achieved due to the through slots 621.

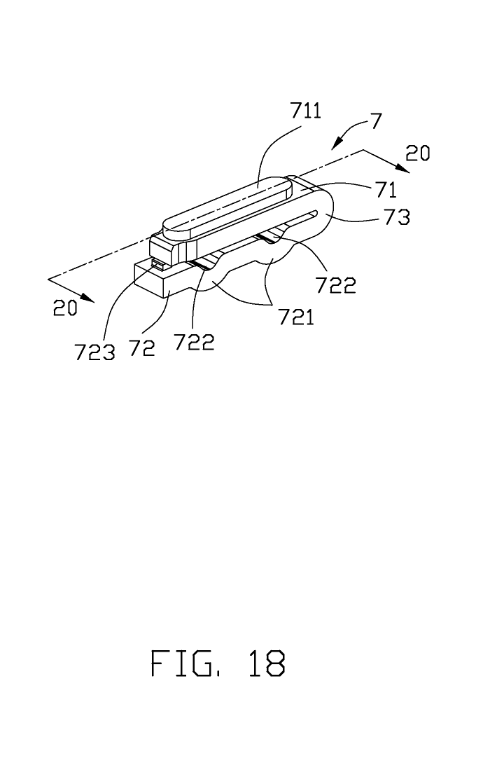

Referring to FIGS. 18 to 20, a terminal 7 in accordance with the seventh embodiment of present invention is detailed described as below. The terminal 7 is formed by once folding process and generally structured in a U-shape. The terminal 7 comprises an upper arm 71, a lower arm 72 paralleled with the upper arm 71 and a curved connecting arm 73 connected with the upper arm 71 and the lower arm 72. The lower arm 72 defines two protrusions 721 spaced apart with each other along a front to rear direction. Each of protrusion 721 has an arc-shape bottom surface. The lower arm 72 also has two cavities 722 formed on a top surface thereof and in alignment with the two protrusions 721 in a vertical direction. Each of cavity 722 has an arc-shape bottom surface. The lower arm 72 defines a projection 723 attached to a bottom surface of the upper arm 71. The projection 723 is formed on a top surface and a front side of the lower arm 72. The lower arm 72 also defines a recess 724 in alignment with the projection 723 along a vertical direction. The upper arm 71 defines a rectangular convex plate 711 formed on a top surface thereof and a depression/recess 712 formed on a bottom surface thereof And, a periphery of top surface of the upper arm 71 is not covered by the convex plate 711. A top surface of the convex plate 711 is a mating area of the terminal 7 for signal transmission. A bottom surface of the lower arm 72 is a soldering area of the terminal 7 for soldering to a printed circuit board. The terminal 7 is formed by stamping process. The depression 712 is in alignment with the convex plate 711 along a vertical direction. It should be noted that the two protrusions 721 are used to achieve a fully integration between soldering paste (not labeled) located on the conductive pad of the printed circuit board and the corresponding terminal 7. Thus, a good mechanical and electrical connection between the printed circuit board and the terminal 7 is achieved due to the protrusions 721.

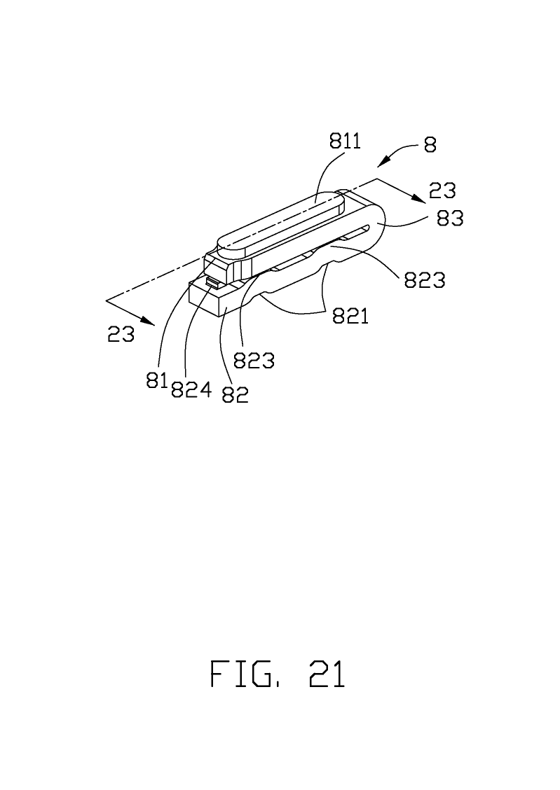

Referring to FIGS. 21 to 23, a terminal 8 in accordance with the eighth embodiment of present invention is detailed described as below. The terminal 8 is formed by once folding process and generally structured in a U-shape. The terminal 8 comprises an upper arm 81, a lower arm 82 paralleled with the upper arm 81 and a curved connecting arm 83 connected with the upper arm 81 and the lower arm 82. The lower arm 82 defines two grooves 821 formed on a bottom surface thereof and spaced apart with each other along a front-to-rear direction. Each of grooves 821 extends throughout two sides of the lower arm 82. The lower arm 82 further defines a recess 822 located in front of the groove 821. The lower arm 82 further defines two protrusions 823 in alignment with the two grooves 821 in a vertical direction. The upper arm 81 defines a rectangular convex plate 811 formed on a top surface thereof and a depression 812 formed on a bottom surface thereof And, a periphery of top surface of the upper arm 81 is not covered by the convex plate 811. A top surface of the convex plate 811 is a mating area of the terminal 8 for signal transmission. A bottom surface of the lower arm 82 is a soldering area of the terminal 8 for soldering to a printed circuit board. The terminal 8 is formed by stamping process. The depression 812 is in alignment with the convex plate 811 along a vertical direction. It should be noted that the two grooves 821 are used to achieve a fully integration between soldering paste (not labeled) located on the conductive pad of the printed circuit board and the corresponding terminal 8. Thus, a good mechanical and electrical connection between the printed circuit board and the terminal 8 is achieved due to the grooves 821.

The terminals in accordance with all embodiments of present invention are folding type. Each terminal is formed by a thin copper plate which is bent 180 degrees. Thus, a thickness of the terminal is increased to meet a requirement of a thickness of a mating portion of the terminal. Compared to the terminal of existing technology, the terminal of present invention can not only meet a thickness requirement, but also can save copper material for manufacturing. Thus, the terminal of present invention has an advantage of lower manufacturing cost. It should be noted that a thickness of the copper plate for manufacturing the terminal is thin. In other word, upper arm, lower arm and the curved arm are all thinner than a thickness of the terminal of existing technology. Thus, impedance value of present invention terminal is lower. So, signal through the terminal of present invention is strong to meet a signal transmission requirement of the terminal.

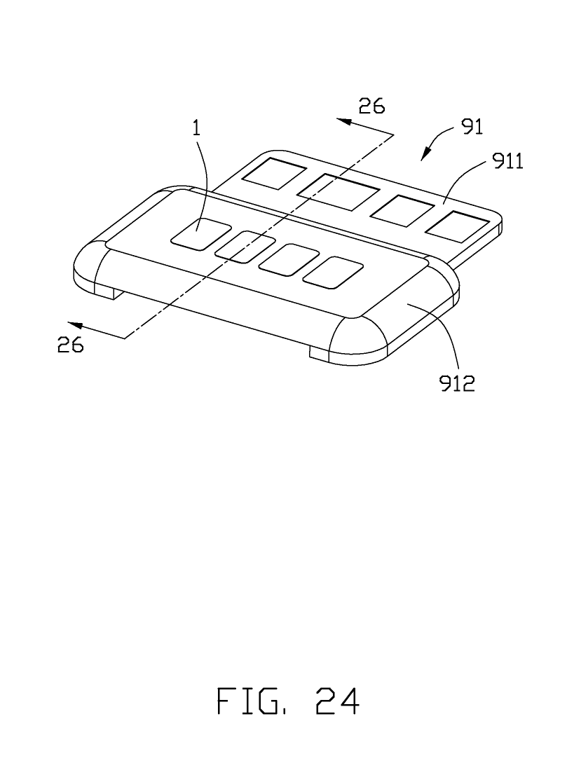

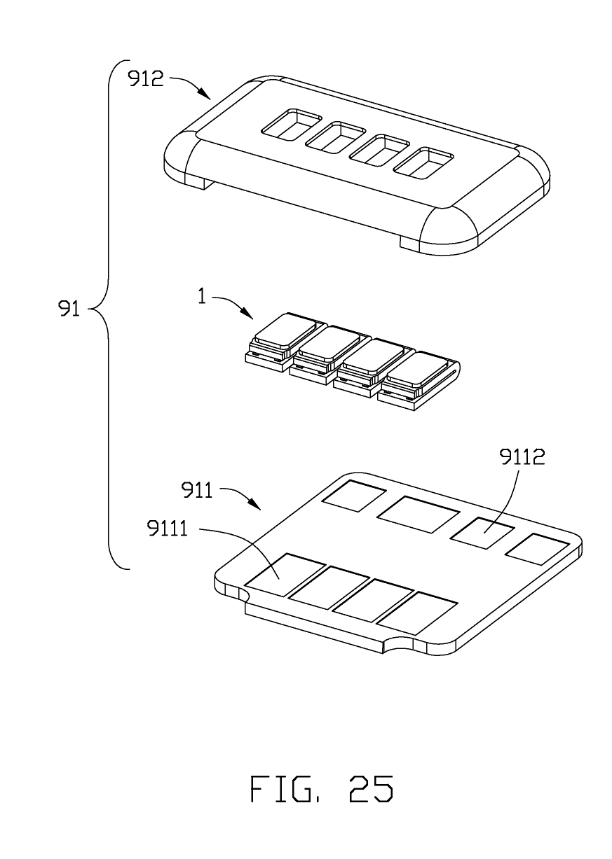

Referring to FIGS. 24 to 26, a terminal module 91 in accordance with the first embodiment of present invention is detailed described as below. The terminal module 91 comprises a printed circuit board 911, and a plurality of terminals 1 soldered to the printed circuit board 911. The structure of terminal 1 is no longer described in detailed here. You can refer to detailed description as mentioned above and in conjunction with FIGS. 1, 2 and 26. The terminal module 91 further comprises an insulator 912 formed on a connection between the terminals 1 and the printed circuit board 911. The terminal 1 has a top surface exposed out of the insulator 912 and flushed with top surface of the insulator 912. The printed circuit board 911 defines a plurality of front and rear conductive pads 9111, 9112 formed on a top surface thereof and respectively formed at two opposite front and rear sides thereof The rear conductive pads 9112 can be used to electrically connected with other electronic component(not shown).

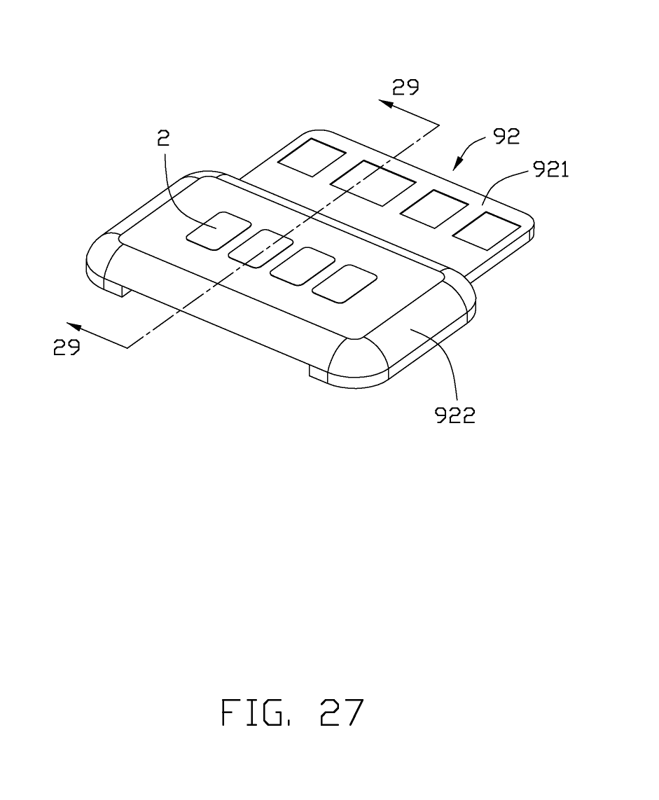

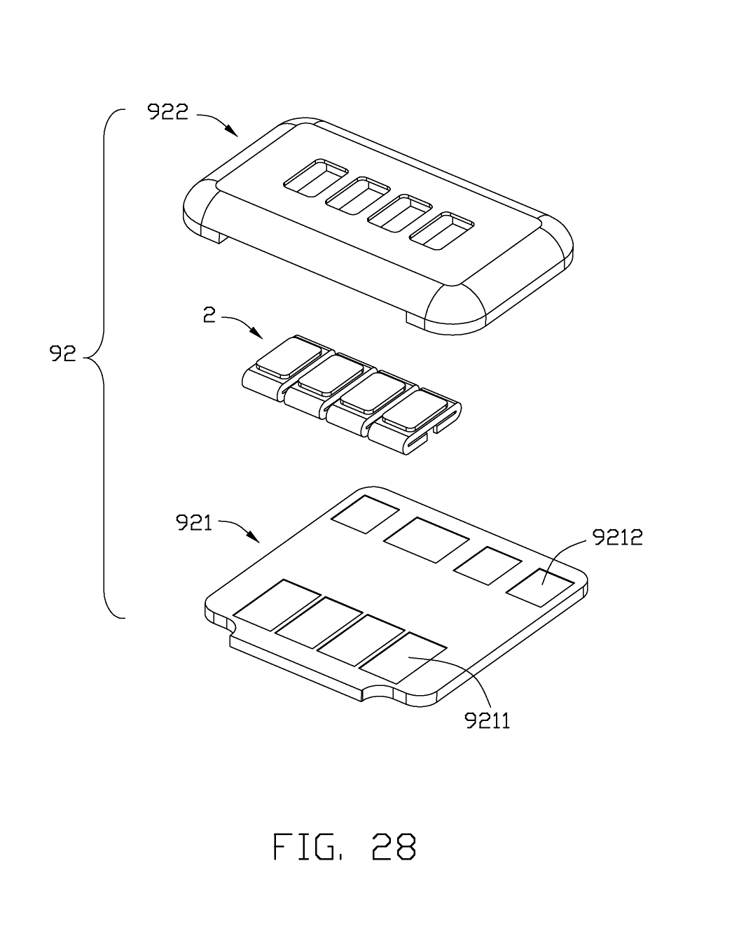

Referring to FIGS. 27 to 29, a terminal module 92 in accordance with the second embodiment of present invention is detailed described as below. The terminal module 92 comprises a printed circuit board 921, and a plurality of terminals 2 soldered to the printed circuit board 921. The structure of terminal 2 is no longer described in detail here. You can refer to detailed description as mentioned above and in conjunction with FIGS. 5, 6 and 29. The terminal module 92 further comprises an insulator 922 formed on a connection between the terminals 2 and the printed circuit board 921. The terminal 2 has a top surface exposed out of the insulator 922 and flushed with top surface of the insulator 922. The printed circuit board 921 defines a plurality of front and rear conductive pads 9211, 9212 formed on a top surface thereof and respectively formed at two opposite front and rear sides thereof The rear conductive pads 9212 can be used to electrically connected with other electronic component(not shown).

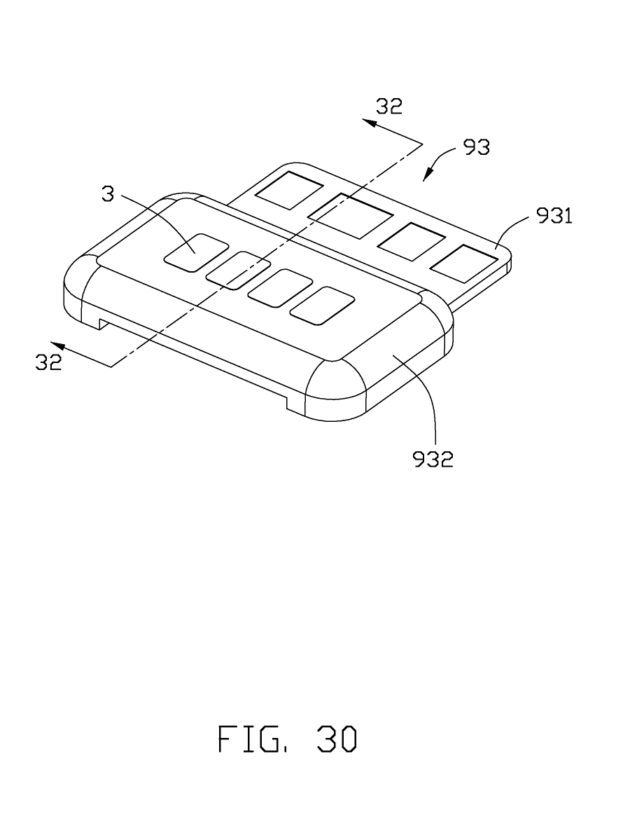

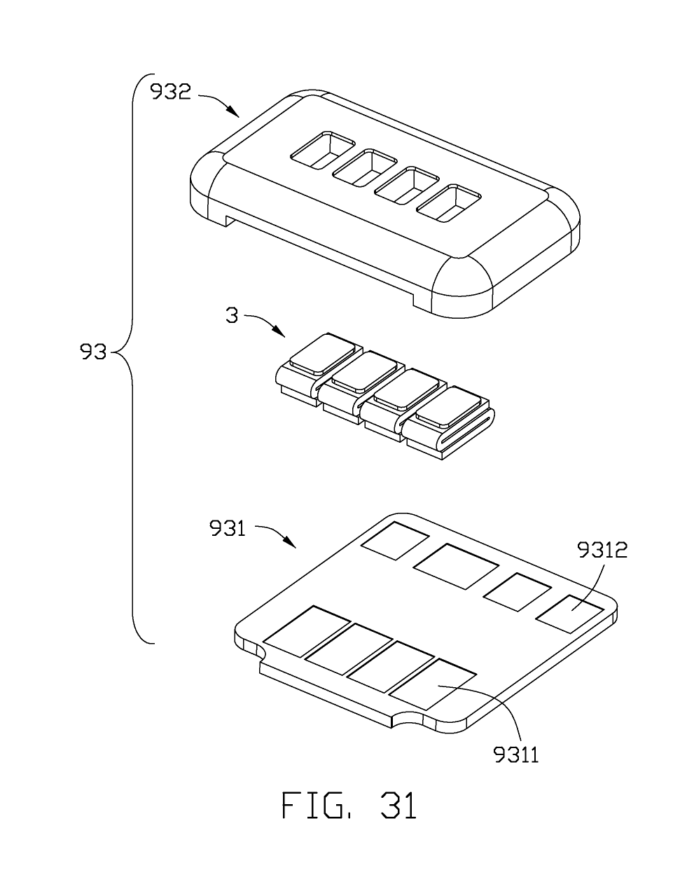

Referring to FIGS. 30 to 32, a terminal module 93 in accordance with the third embodiment of present invention is detailed described as below. The terminal module 93 comprises a printed circuit board 931, and a plurality of terminals 3 soldered to the printed circuit board 931. The structure of terminal 3 is no longer described in detail here. You can refer to detailed description as mentioned above and in conjunction with FIGS. 7, 8 and 32. The terminal module 93 further comprises an insulator 932 formed on a connection between the terminals 3 and the printed circuit board 931. The terminal 3 has a top surface exposed out of the insulator 932 and flushed with top surface of the insulator 922. The printed circuit board 931 defines a plurality of front and rear conductive pads 9311, 9312 formed on a top surface thereof and respectively formed at two opposite front and rear sides thereof The rear conductive pads 9312 can be used to electrically connected with other electronic component(not shown).

Referring to FIGS. 24 to 26, the assembling process of the terminal module 91 made in according to the first embodiment of the present invention comprises following assembling steps. Firstly, providing a plurality of folding type terminals 1 and a printed circuit board 911 having a plurality of front conductive pads 9111 formed on a top surface and a front end thereof Secondly, putting a plurality of soldering pastes (not shown in figures) on corresponding front conductive pads 9111 of the printed circuit 911. Thirdly, putting the plurality of terminals 1 on the corresponding soldering pastes through a fixture (not shown in figures). It should be noted that the plurality of terminals 1 also be positioned by the fixture. Fourthly, soldering the plurality of terminals 1 to the front conductive pads 9111 through hot-bar, or SMT(surface mount technology) or laser welding process. At last, molding an insulator 912 on a connection between the plurality of terminals 1 and the printed circuit board 911. After the above assembling steps, the entire process of assembling of the terminal module 91 is finished. It should be noted that the terminals 1 provided in first step are partially gold-plated on outer surface thereof. Alternatively, the terminals 1 provided in first step are formed by two steps. Firstly, the terminals 1 are entirely gold-plated on outer surface thereof Then the terminals 1 are partially gold-stripping from the terminals through laser-welding process. Thus, during soldering process, the solder paste can be prevented from climbing to top surface of the terminal 1. As a result, appearance of terminals 1 and signal transmission of terminals 1 will not be influenced. And, the assembling process of the terminal modules 92, 93 made in according to the second and third embodiments of the present invention also comprises same assembling steps as mentioned above. And, the terminals in accordance with fourth to eighth embodiments of the present invention can be soldered to the printed circuit board through same assembling process as mentioned above.

As a bottom surface of the lower arm of terminals in accordance with all embodiments of present invention is a soldering area, so the solder paste will climb up by through slots, protrusions and grooves formed on the lower arm when the terminals are soldered to the printed circuit board. Thus, two adjacent solder paste will not connected with each other to result in short circuit phenomenon. Meanwhile, terminals and the printed circuit board are well soldered together.

It will be understood that the invention may be embodied in other specific forms without departing from the spirit or central characteristics thereof The present examples and embodiments, therefore, are to be considered in all respects as illustrative and not restrictive, and the invention is not to be limited to the details given herein.

What is claimed is:

1. A terminal comprising:
an upper arm having a top surface for a mating area;
a lower arm paralleled with the upper arm and having a bottom surface soldering area; and
a connecting arm connected with the upper arm and the lower arm.

2. The terminal as recited in claim 1, wherein the whole terminal is structured in a folded manner with a tiny gap therebetween in a vertical direction, and one of said upper arm and said lower arm forms a projection in said gap to abut against the other in a vertical direction.

3. The terminal as recited in claim 2, wherein said one of the upper arm and the lower arm forms a recess corresponding to the projection in said vertical direction.

4. The terminal as recited in claim 1, wherein the upper arm defines a convex plate formed on the top surface thereof and having a top surface, and the mating area is the top surface of the convex plate.

5. The terminal as recited in claim 4, wherein the upper arm defines a recess in a bottom surface thereof corresponding to said convex plate in a vertical direction.

6. The terminal as recited in claim 1, wherein the lower arm defines at least one through slot extending throughout top and bottom surfaces thereof

7. The terminal as recited in claim 6, wherein at least one through slot comprise two through slots paralleled with each other and spaced apart with each other along a transversal direction.

8. The terminal as recited in claim 6, wherein at least one through slot comprise two through slots spaced apart with each other along a front to rear direction.

9. The terminal as recited in claim 6, wherein at least one through slot comprise two through slots formed on two lateral sides of the lower arm.

10. The terminal as recited in claim 1, wherein the lower arm defines protrusions or grooves formed on the bottom surface thereof

11. A terminal module comprising:
a printed circuit board having a plurality of front and rear conductive pads; and
a plurality of terminals soldered to the printed circuit board;
wherein each of terminal comprises paralleled upper and lower arms and a connecting arm connected with the upper arm and the lower arm, the upper arm defines a contacting area on a top surface thereof, the lower arm defines a soldering area on a bottom surface thereof, the plurality of terminals are located on the plurality of corresponding front conductive pads, and the lower arms of the plurality of terminals are soldered to the plurality of corresponding front conductive pads.

12. The terminal module as recited in claim 10, wherein the lower arm defines at least one through slots extending throughout top and bottom surfaces thereof

13. The terminal module as recited in claim 10, wherein the lower arm defines at least one protrusion or groove formed on the bottom surface thereof

14. The terminal module as recited in claim 10, wherein the lower arm defines a projection formed on a top surface thereof and attached to a bottom surface of the upper arm.

15. The terminal module as recited in claim 10, wherein the terminal module further comprises an insulator molding on a connection between the plurality of terminals and the printed circuit board.

16. A method of manufacturing a terminal module, comprising the steps of:
providing a plurality of folding type terminals and a printed circuit board having a plurality of front conductive pads formed on a top surface and a front end thereof;
applying a plurality of soldering pastes on corresponding front conductive pads of the printed circuit;.
applying the plurality of terminals on the corresponding soldering pastes through a fixture; and
soldering the plurality of terminals to the front conductive pads through hot-bar, or SMT(surface mount technology) or laser welding process.

17. The method of manufacturing the terminal module as recited in claim 15, wherein further molding an insulator on a connection between the plurality of terminals and the printed circuit board.

18. The method of manufacturing the terminal module as recited in claim 15, wherein the terminal comprises paralleled upper arm and lower arm and a curved connecting arm connected with the upper arm and the lower arm.

19. The method of manufacturing the terminal module as recited in claim 17, wherein the lower arm defines a projection formed on a top surface thereof and attached to a bottom surface of the upper arm.

20. The method of manufacturing the terminal module as recited in claim 17, wherein the terminals provided in first step are partially gold-plated on outer surface thereof or partially gold-stripping from the terminals which are entirely gold-plated on outer surface through laser-welding process.
